(19) United States
(12) Patent Application Publication
(10) Pub. No.: US 2006/0027533 A1
(43) Pub. Date: Feb. 9, 2006

(54) System for dynamic slurry delivery in a CMP process

(76) Inventor: Yaojian Leng, Plano, TX (US)

Correspondence Address: TEXAS INSTRUMENTS INCORPORATED, P O BOX 655474, M/S 3999, DALLAS, TX, 75265, US

(21) Appl. No.: 10/913,640

(22) Filed: Aug. 6, 2004

(51) Int. Cl. C03C 15/00; B44C 1/22; C23F 1/00

(52) U.S. Cl. 216/84; 156/345.12; 156/345.13; 438/692; 216/88; 216/89

(57) ABSTRACT

The present invention provides a system (100) for dynamic slurry delivery during a semiconductor polishing process. A dispensing component (118) is adapted to dispense a slurry material (116) onto a polishing pad (108). A support structure (120) supports the dispensing component at any of a plurality of locations (122, 126) along a radius of the polishing pad. An actuating component (124) is coupled to the support structure and adapted to position the dispensing component at any of the plurality of locations, responsive to a control signal from a control component (128). A monitoring component (130) acquires profile data from the surface (114) of semiconductor wafer (112) being polished. The control component receives that profile data, and from that data determines a desired location for the dispensing component. The control component then provides a control signal to the actuating component to position the dispensing component at the desired location.

### TECHNICAL FIELD OF THE INVENTION

The present invention relates generally to the field of semiconductor devices and, more particularly, to apparatus and methods for dynamically adjustable point-of-delivery for chemical-mechanical polishing (CMP) slurry.

### BACKGROUND OF THE INVENTION

The continual demand for enhanced integrated circuit performance has resulted in, among other things, a dramatic reduction of semiconductor device geometries, and continual efforts to optimize the performance of every substructure within any semiconductor device. A number of improvements and innovations in fabrication processes, material composition, and layout of the active circuit levels of a semiconductor device have resulted in very high-density circuit designs. Increasingly dense circuit design has not only improved a number of performance characteristics, it has also increased the importance of, and attention to, semiconductor material properties and behaviors.

The increased packing density of the integrated circuit generates numerous challenges to the semiconductor manufacturing process. Every device must be smaller without damaging the operating characteristics of the integrated circuit devices. High packing density, low power consumption and good reliability must be maintained without any functional device degradation. Increased packing density of integrated circuits is usually accompanied by smaller feature size.

As integrated circuits become denser, the widths of interconnect layers that connect transistors and other semiconductor devices of the integrated circuit are reduced. As the widths of interconnect layers and semiconductor devices decrease, their resistance increases. As a result, semiconductor manufacturers seek to create smaller and faster devices by using, for example, a copper interconnect instead of a traditional aluminum interconnect. Unfortunately, copper is very difficult to etch in most semiconductor process flows. Therefore, damascene processes have been implemented to form copper interconnects.

Damascene methods usually involve forming a trench and/or an opening in a dielectric layer that lies beneath and on either side of the copper-containing structures. Once the trenches or openings are formed, a blanket layer of the copper-containing material is formed over the entire device. The thickness of such a layer must be at least as thick as the deepest trench or opening. After the trenches or openings are filled with the copper-containing material, the copper-containing material over them is removed, e.g., by chemical-mechanical polishing or planarization (CMP), so as to leave the copper containing material in the trenches and openings but not over the dielectric or over the uppermost portion of the trench or opening.

During CMP, slurry is typically applied to the surface of a circular polishing pad as the pad polishes the surface of a semiconductor wafer. The polishing pad rotates about some axis, usually its center, during polishing. Generally, the semiconductor wafer is mounted to a polishing head, which also rotates in the same or opposite direction as the polishing pad. The polishing head is used to bring the semiconductor wafer—particularly the surface of the wafer to be polished—into contact with the polishing pad. The polishing head is also commonly used to forcefully press the wafer's surface against the polishing pad in order to facilitate the polishing process. A slurry, or some slurry component, is applied to the pad as polishing begins, or during the course of polishing.

Ideally, a post-CMP wafer should have a consistent, uniform profile across the entire polished surface. Metal or barrier dimensions near the edge of a wafer should be identical to those near the center of the wafer. In reality, however, there are a number of variables inherent in most CMP processes that introduce a number of non-uniformities into the polishing process. Some of those variables concern variations in consumable products utilized during the CMP process (e.g., pad wear, slurry variations, head wear). Other variables are introduced by the physical configuration and operation of CMP apparatus—such as the pressing force or alignment of the polishing head, or the position, relative to the wafer, at which slurry is dispensed onto the polishing pad. Furthermore, the profile of the wafer as it is prepared for CMP may already have a number of non-uniformities resulting from pre-CMP processes (e.g., electrochemical plating).

If these variables are left unaddressed, resulting non-uniformities can cause a number of device reliability and yield problems. For example, variations in slurry composition or pad wear patterns may result in insufficient polishing of metal structures along certain portions of a wafer's surface (i.e., underpolish). In such a case, remaining metal that should have otherwise been removed can cause shorts between subsequently formed structures—causing a number of performance or reliability problems.

Where such variables are addressed, conventional systems commonly rely on overcompensation schemes, such as overpolish processes. These processes usually involve polishing critical structures past a target dimension—a dimension that provides an optimal balance of performance and manufacturability. The entire wafer is polished beyond the target dimension by some margin sufficient to ensure that—even with variable-induced non-uniformities across the wafer's surface—all structures along the surface have been polished to at least the target dimension. This also results, of course, in a significant number of structures along the surface being polished well beyond the target dimension. Such processes are wasteful and inefficient and, as submicron device geometries continue to shrink, they may have a detrimental impact on device performance.

Some manufacturing systems have attempted to control post-CMP wafer profiles by providing polishing heads having multiple pressure zones. Such systems are generally adapted to provide differing pressures at a plurality of zones along the polishing head. For example, such a polishing head may be adapted to provide different pressure levels at the center and edge of a wafer secured to the head. Typically, however, modifying existing manufacturing systems to incorporate such multiple-zone heads can introduce an extensive amount of apparatus downtime, equipment upgrade, and operational cost and overhead into the manufacturing process. Furthermore, multiple-zone head systems are expensive—generally rendering them somewhat cost prohibitive for otherwise cost sensitive high volume commercial processes.

Some other attempts have been made to control post-CMP wafer profiles by requiring manufacturers to choose from one of several predefined, fixed positions for a slurry dispensing nozzle. Generally, the position of the nozzle, in relation to the polishing pad, is set as the CMP apparatus is placed into service. Such systems typically require some amount of manual adjustment in order to set the nozzle position, and offer only a limited number of predefined set positions. This somewhat limits the ability to the CMP apparatus to accommodate a large variety of mature and newly developed semiconductor technologies. Furthermore, routine and continuous wafer-to-wafer adjustment or, even more importantly, routine adjustment during polish of a single wafer (i.e., intrawafer adjustment), is either not possible with such systems or it not commercially feasible, due to the labor and delays caused by each adjustment. Minor aberrations occurring during the polish of a single wafer generally cannot be addressed by such systems. This can ultimately result in a certain degree of post-CMP profile non-uniformities remaining across or within wafer lots.

As a result, there is a need for a system that provides dynamically adjustable point-of-delivery for CMP slurry—a system that is capable of routine and continuous intrawafer adjustment while obviating the need for overcompensation schemes—providing optimal and uniform post-CMP wafer profiles on a wafer-to-wafer basis in an easy, efficient and cost-effective manner.

### SUMMARY OF THE INVENTION

The present invention provides a versatile system, comprising a number of apparatus and methods, for dynamic slurry delivery in an easy, efficient and cost-effective manner. The system of the present invention may be readily implemented within a variety of CMP systems and provides for easy, automated adjustment of slurry point-of-delivery. The system of the present invention provides real-time point-of-delivery tuning—operable on an intrawafer, wafer-to-wafer, or lot-to-lot basis. Introduction of the present invention does not limit the processing capacity or versatility of a CMP apparatus. The system of the present invention obviates the need for overcompensation and other similar correction schemes, and provides optimal, uniform post-CMP wafer profiles.

Comprehending certain complications and limitations that arise from conventional variance correction or compensation approaches, the system of the present invention addresses non-uniformities in post-CMP wafer profiles by providing real-time, dynamic adjustment of the position of a slurry delivery component (e.g., nozzle) in relation to a polishing pad. The present invention provides a monitoring component that analyzes a wafer profile during the polish process. A feedback component determines what, if any, adjustment is needed in the position of the delivery component. If adjustment is required, a control component then moves the delivery component radially across the polishing pad to a desired position. This process repeats continuously throughout the polish process. Once polish commences on a new wafer, the position of the delivery component may be left in its last adjusted position, or may be reset to some desired baseline position.

Specifically, present invention provides a system for dynamic slurry delivery during a semiconductor polishing process. A dispensing component is adapted to dispense a slurry material onto a polishing pad. A support structure supports the dispensing component at any of a plurality of locations along a radius of the polishing pad. An actuating component is coupled to the support structure and adapted to position the dispensing component at any of the plurality of locations, responsive to a control signal from a control component. A monitoring component acquires profile data from the surface of semiconductor wafer being polished. The control component receives that profile data, and from that data determines a desired location for the dispensing component. The control component then provides a control signal to the actuating component to position the dispensing component at the desired location.

More specifically, certain embodiments of the present invention provide a system for polishing a semiconductor wafer that comprises a polishing pad, having an abrasive surface, and a polishing head, adapted to move a first surface of a semiconductor wafer into abrasive contact with the abrasive surface. A dispensing component is adapted to dispense a slurry material onto the polishing pad. A support structure supports the dispensing component at a plurality of locations along a radius of the polishing pad. An actuating component is coupled to the support structure and adapted to position the dispensing component at any of the plurality of locations, responsive to a control signal. A monitoring component is disposed in proximity to, and adapted to acquire profile data characterizing, the first surface of the semiconductor wafer. A control component is communicatively coupled to the actuating and monitoring components, and is adapted to analyze the profile data, to determine from the profile data a desired location for the dispensing component, and to provide a control signal to the actuating component to position the dispensing component at the desired location.

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 provides an illustration depicting one embodiment of a CMP system according to the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The present invention is hereafter illustratively described in conjunction with the dynamic adjustment of delivery mechanisms for polishing slurries and slurry components used chemical mechanical polishing systems. The specific embodiments discussed herein are, however, merely demonstrative of specific ways to make and use the invention and do not limit the scope of the invention.

The present invention addresses non-uniformities in post-CMP wafer profiles by providing real-time, dynamic adjustment of the relative position of a slurry delivery component (e.g., nozzle). The present invention provides a monitoring component that analyzes or measures the profile of a wafer while that wafer is being polished. From that monitoring, a feedback component determines what, if any, adjustment is needed in the position of the slurry delivery component. If adjustment is required, a control component then moves the delivery component radially across the polishing pad to a desired position. The control component and the delivery component are formed or assembled such that a very large (almost infinite) number of positions for the delivery component are available. Monitoring and adjustment, when needed, are performed continuously throughout the polish process. Once polish commences on a new wafer, the position of the delivery component may be left in its last adjusted position, or may be reset to some desired baseline or starting position.

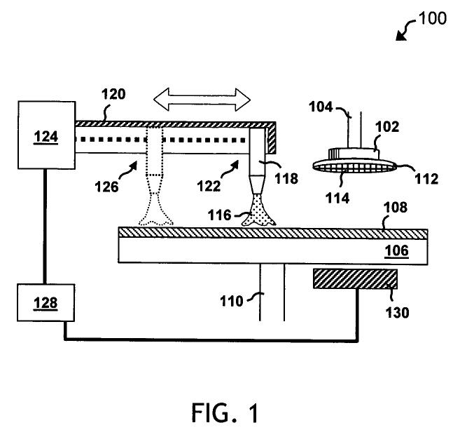

The features and operations of the present invention are described in greater detail with reference now to FIG. 1, which depicts an illustrative embodiment of a CMP system 100 according to the present invention. System 100 comprises a polishing head 102, mounted to and operable by a spindle 104. A polishing platform 106 has a polishing pad 108 disposed along its top side, and is mounted to and operable by a spindle 110. A semiconductor wafer 112 is mounted to the lower surface of head 102. Wafer 112 has a lower surface 114, which is the surface to be polished during CMP.

Once polishing begins, spindle 110 begins to spin platform 106 and pad 108. Head 102 is lowered by spindle 104, such that surface 114 comes into sufficient abrasive contact with an abrasive upper surface of pad 108. Depending upon the nature of system 100 or the particular components utilized therein, head 102 and spindle 104 may begin to spin, either in the same or opposite direction as pad 108, and may exert differing amounts of downward force upon wafer 112, in order to induce differing rates of polish along surface 114. Once polish begins, and either continuously or at varying periods during polish, a slurry material 116 is applied to pad 108 by a dispensing component 118. Material 116 may comprise any desired single or multi-component slurry material or mixture (e.g., metal selective slurry, barrier selective slurry). Dispensing component 118 comprises any appropriated dispensing apparatus in accordance with the present invention. As depicted in FIG. 1, component 118 comprises a nozzle.

Component 118 is mounted to and supported by a positioning structure 120. Structure 120 may comprise any suitable fixed or retractable structure (e.g., a track, boom, robotic arm) capable of housing component 118 and any necessary supply lines or connections to component 118, and capable of repositioning component 118 radially in relation to pad 108. Structure 120 is formed or assembled of a sufficient dimension to support radial movement of component 118 from a position at the outer edge of pad 108 to a position at the center of pad 108. In the embodiment depicted in FIG. 1, component 118 starts at a baseline, or default, position near the center of pad 108. When, during polish, a determination is made that the position of component 118 needs to be adjusted, actuating component 124 initiates the operation(s) necessary to move component 118 from the baseline position 122 to an adjusted position 126.

Depending upon the specific nature and configuration of structure 120, component 124 may comprise a wide variety of apparatus suitable for moving component 118 in conjunction with structure 120. For example, if component 118 comprises a structure that is distally slidable along a track assembly 120, then component 124 may comprise a belt drive assembly and motor. If structure 120 comprises a retractable boom, component 124 may comprise a solenoid or hydraulic assembly. If structure 120 comprises a robotic assembly (e.g., a robotic arm), component 124 may comprise an electromechanical base for that assembly. These and a host of other variations and combinations are hereby comprehended. Regardless of their specific implementation, structure 120 and component 124 provide system 100 with the ability to move component 118 quickly and precisely along a radius of pad 108.

Component 124 initiates the movement of component 118 responsive to communication or a signal from a control component 128. Component 128 is communicatively coupled to component 124 and to a monitoring component 130. The communicative links may be actual physical links (e.g., cables, wires) or remote links (e.g., wireless, optical). Monitoring component 130 is disposed within system 100 in proximity to the position of surface 114 during polish, and is used to measure or otherwise profile the progress of polishing on surface 114. Depending upon the operational nature of component. 130, it may be disposed beneath platform 106, to the side of platform 106 or above pad 108 adjacent to wafer 112. Depending upon the physical properties and behaviors of materials along surface 114, component 130 may comprise any optical, electric or electromagnetic system or apparatus suitable for acquiring data characterizing or measuring features or structures formed of those materials along surface 114. For example, in certain embodiments of the present invention, component 130 may comprise a laser-based optical measurement system. In other embodiments, for example, component 130 may comprise an electromagnetic characterization system (e.g., a system for generating and detecting eddy currents).

As depicted in FIG. 1, component 130 comprises an electromagnetic system disposed under platform 106 in vertical alignment with wafer 112. During polish of metal features, component 130 generates an oscillating magnetic field upwardly toward surface 114. This field generates eddy current within the conductive metal features along surface 114. Sensing components (e.g., sense coils), within component 130, measure the impedance of those metal features. As polishing removes metal from surface 114, thinning the metal features thereupon, the impedance of those features as measured by component 130 decreases. This impedance measurement information is then communicated to control component 128, which translates, using known information about the electrical properties of the metal, the impedance data into a characterization of the thickness of the metal remaining along surface 114. Given a sufficient range of sensing components within component 130, a real-time profile characterization or map of surface 114 may be compiled and evaluated by component 128.

Control component 128 comprises a processing component (e.g., processor, software running on a processor) that gathers profile data from component 130, and translates that profile data into adjustment data for component 118. Component 128 communicates information to component 124 sufficient to initiate the necessary adjustment in component 118. For example, component 128 may provide an on signal to a motor within component 124 for some small amount of time. In other embodiments, component 128 may provide component 124 with new coordinates for component 118, and rely on processing capabilities within component 124 to initiate the adjustment.

There are a number of embodiments for the translation functionality with control component 128. Control component 128 may, for example, comprise a feedback algorithm that factors in measurement data from component 130 and past command data provided to component 124. In other embodiments, component 128 may implement a look-up table structure that correlates particular profile data to position data for component 118. Other comparable embodiments are further comprehended.

Components 124, 128 and 130 may be implemented in hardware, software or combinations of hardware and software, as independent components or in varying, collocated combinations with one another. For example, components 124 and 128 may be implemented within a single host computer system, while component 130 comprises a stand-alone unit interfaced to that computer system. In other embodiments, component 128 may be implemented in a host computer system, while both components 124 and 130 comprise stand-alone units interfaced to that computer system. These and other comparable variations and combinations are comprehended hereby.

This monitoring and adjustment process continues throughout the polishing of wafer 112—providing an optimized polish specifically for that wafer. Once the profile data from component 130 indicates that a sufficient amount of material has been removed uniformly from surface 114, polishing terminates. A new wafer may be loaded onto head 102, and component 118 may be left in its current position, or reset to some desired starting position. Polishing for the new wafer begins and, utilizing system 100, that polishing process is again optimized for the new wafer.

The embodiments and examples set forth herein are thus presented to best explain the present invention and its practical application, and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. As stated throughout, many modifications and variations are possible in light of the above teaching without departing from the spirit and scope of the following claims.

What is claimed is:

1. A system for polishing a semiconductor wafer, the system comprising:
a polishing pad, having an abrasive surface;
a polishing head, adapted to move a first surface of a semiconductor wafer into abrasive contact with the abrasive surface;
a dispensing component adapted to dispense a slurry material onto the polishing pad;
a support structure adapted to support the dispensing component at a plurality of locations along a radius of the polishing pad;
an actuating component coupled to the support structure and adapted to position the dispensing component at any of the plurality of locations responsive to a control signal;
a monitoring component disposed in proximity to, and adapted to acquire profile data characterizing, the first surface of the semiconductor wafer; and
a control component, communicatively coupled to the actuating and monitoring components, and adapted to analyze the profile data, to determine from the profile data a desired location for the dispensing component, and to provide a control signal to the actuating component to position the dispensing component at the desired location.

2. The system of claim 1, wherein the dispensing component comprises a nozzle.

3. The system of claim 1, wherein the support structure comprises a fixed structure.

4. The system of claim 1, wherein the support structure comprises a retractable structure.

5. The system of claim 1, wherein the support structure comprises a track.

6. The system of claim 1, wherein the support structure comprises a boom.

7. The system of claim 1, wherein the support structure comprises a robotic assembly.

8. The system of claim 1, wherein the control component comprises a feedback algorithm.

9. The system of claim 1, wherein the control component comprises a look-up table.

10. The system of claim 1, wherein the actuating, control and monitoring components are independently located.

11. The system of claim 1, wherein the actuating and control components are collocated.

12. The system of claim 1, wherein the monitoring and control components are collocated.

13. A method of providing dynamic slurry delivery in a semiconductor polishing process, the method comprising the steps of:
providing a dispensing component adapted to dispense a slurry material onto a polishing pad;
providing a support structure adapted to support the dispensing component at a plurality of locations along a radius of the polishing pad;
providing an actuating component coupled to the support structure and adapted to position the dispensing component at any of the plurality of locations responsive to a control signal;
monitoring the surface of semiconductor wafer being polished to acquire profile data characterizing the surface;
analyzing the profile data to determine a desired location for the dispensing component; and
providing a control signal to the actuating component to position the dispensing component at the desired location.

14. The method of claim 13, wherein the step of analyzing the profile data to determine a desired location for the dispensing component further comprises processing the profile data using a feedback algorithm.

15. The method of claim 13, wherein the step of analyzing the profile data to determine a desired location for the dispensing component further comprises utilizing a look-up table to determine the desired location.

16. The method of claim 13, wherein the step of providing a control signal further comprises providing a signal via a physical connection.

17. The method of claim 13, wherein the step of providing a control signal further comprises providing a signal via a remote connection.

18. The method of claim 13, wherein the step of monitoring the surface of semiconductor wafer comprises optical measurement of the surface.

19. The method of claim 13, wherein the step of monitoring the surface of semiconductor wafer comprises electromagnetic characterization of the surface.
